(19) United States
(12) Patent Application Publication
(10) Pub. No.: US 2008/0255305 A1
(43) Pub. Date: Oct. 16, 2008

(54) Biological Molecule-Reactive Hydrophilic Silicone Surface

(75) Inventors: Michael A. Brook, Ancaster (CA); Heather Sheardown, Nobleton (CA); Hong Chen, Hubel (CN)

Correspondence Address: BERESKIN AND PARR, 40 KING STREET WEST, BOX 401, TORONTO, ON, M5H 3Y2, CA

(73) Assignee: McMASTER UNIVERSITY, Hamilton, ON (CA)

(21) Appl. No.: 11/569,277

(22) PCT Filed: May 17, 2005
(86) PCT No.: PCT/CA2005/000739

§ 371 Date: Mar. 11, 2008

Related U.S. Application Data
(60) Provisional application No. 60/571,522, filed on May 17, 2004.

(51) Int. Cl. C08G 77/38

(52) U.S. Cl. 525/103; 525/474; 525/100; 525/418; 525/403; 427/2.24; 427/2.11

(57) ABSTRACT

A silicone polymer having a modified surface is described, wherein said modification consists of a covalently attached water soluble polymer bearing an activating group, wherein said activating group reacts with reactive functionalities on one or more biological molecules so that said one or more biological molecules become covalently attached to said silicone polymer. The modified silicones are reacted with biological molecules to make them more biocompatible for use in biodiagnostic, biosensor or bioaffinity applications, or for coatings for in vivo transplantation or for liners exposed to biological broths.

### FIELD OF THE INVENTION

The present invention relates to modified silicone materials, specifically silicone materials that have been modified so that they are biocompatible, as well as to methods of making such materials.

### BACKGROUND OF THE INVENTION

When synthetic biomaterials are implanted, they are met with a complex and aggressive biological system that ultimately passivates the material or creates a fibrotic capsule, essentially walling the material off from the system with which it was to interact. Various synthetic strategies have made impressive inroads to the problems of preparing compatible biomaterials (¹). One promising approach exploits the plasma polymerization of hydrophilic monomers such as alkylamines or tetraglyme onto an existing polymer surface (^{2,3,4}). However, likely the most general and powerful methods (⁵) involve the formation of layers of hydrophilic polymers, of which oligo- (^{6,7,8}) and poly(ethylene oxide)(^{9,10,11,12}) are exemplary, on the surface. The polymers either bloom from polymer blends to an aqueous interface, or are covalently grafted onto an activated polymer surface (^{13,14}). While promising, it is clear that more biocompatible surfaces can be produced when constituents of the local biology are harnessed to “bioactivate” the surface (¹⁵), either alone or in combination with hydrophilic polymers. Such approaches include modification with amino acids, cell adhesion peptides, growth factors, and (glyco)proteins. These materials are generally tethered at multiple sites, reducing the mobility of the linking chain. The specific spacing of the tethered biomolecules from the polymer interface is not normally controllable.

Silicone polymers offer many advantages as biocompatible supports, including their very high oxygen transmissibility and the ease with which a variety of different substrates can be conformally coated using several different crosslinking processes. Silicones possess, however, an extremely high surface hydrophobicity to which biomolecules readily adhere (^{16,17}) generally resulting, in the case of proteins, in the subsequent mediation of biological reactions (¹⁵).

Polyethylene glycol (PEO), a water soluble, nontoxic, and nonimmunogenic polymer, has been widely shown to improve the biological compatibility of materials. The presence of a layer of PEO on a biomaterial surface is accompanied by reductions in protein adsorption, and cell and bacterial adhesion (^{18,19,20,21}). While silicones do not normally possess appropriate surface functional groups that could be used to tether passivating polymers such as PEO, several approaches have been developed to introduce organic functionalities on silicone surfaces including the use of a mercury lamp to create radicals (²²) and oxidation by an O₂-based plasma to give alcohols and more highly oxidized species (²³). Alternative methods exploit plasma polymerization of various molecules to generate a functional surface for subsequent modification (^{24,25,26}). However, these methods require several synthetic steps, are not always reproducible and often result in incomplete surface coverage with the functional molecule of interest (²⁷).

The remains a need for an efficient and general method to introduce functionalities onto silicone surfaces that will render these materials biocompatible.

### SUMMARY OF THE INVENTION

The present inventors have developed a flexible, asymmetric linker that provides a facile route to convert hydrophobic silicones into activated ester-terminated, PEO-modified surfaces. These surfaces react effectively with nucleophiles, such as amines and alcohols, and thus serve as key intermediates in the preparation of saccharide-, peptide-, nucleotide-modified and analogous surfaces. High density films of biomolecules, including the peptides, RGD and YIGSR, proteins (epidermal growth factor (EGF), albumin, fibrinogen, mucin and lysozyme) and the glycoprotein heparin, have been prepared on silicone. The resulting surfaces are thus tailored to be selectively repellent or adherent to biomolecules and, as a result, biocompatible in a variety of applications.

Accordingly, the present invention relates to a silicone polymer having a modified surface wherein said modification consists of a covalently attached water soluble polymer bearing an activating group, wherein said activating group reacts with reactive functionalities on one or more biological molecules so that said one or more biological molecules become covalently attached to said silicone polymer.

The present invention further relates to a silicone polymer having the general Formula I:

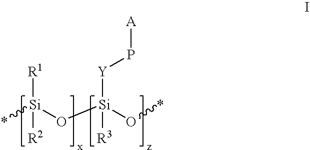

wherein
x is an integer between, and including, 1-20000;
z is an integer between, and including, 1 and 1000;
R¹, R² and R³ are each, independent of one another, selected from H, C₁₋₃₀alkyl, C₂₋₃₀alkenyl, C₂₋₃₀alkynyl and aryl, with the latter four groups being unsubstituted or substituted with one or more groups independently selected from halo, OH, NH₂, NHC₁₋₆alkyl, N(C₁₋₆alkyl)(C₁₋₆alkyl), OC₁₋₆alkyl and halo-substituted C₁₋₆alkyl;
Y is a linker group;
P is a water soluble polymer; and
A is an activating group wherein said activating group reacts with reactive functionalities on one or more biological molecules so that said one or more biological molecules become covalently attached to said silicone polymer.

The polymer of Formula I may also be tethered to another polymer using, for example, the substituents on R¹, R² and/or R³, or through crosslinking reactions known to those skilled in the art, or may be the result of the formation of an interpenetrating network. The polymer of Formula I may also be an elastomer, in which R¹, R² and/or R³ forms a bridge to an adjacent polymeric chain.

In an embodiment of the invention, the water soluble polymer, P, is polyethylene oxide, and the activating group is an activated carboxylic acid. Accordingly, the present invention further relates to a silicone polymer having the general Formula Ia:

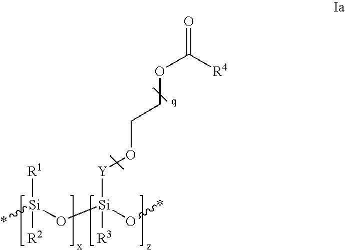

wherein
x is an integer between, and including, 1-20000;
z is an integer between, and including, 1 and 1000;
R¹, R² and R³ are each, independent of one another, selected from H, C₁₋₃₀alkyl, C₂₋₃₀alkenyl, C₂₋₃₀alkynyl and aryl, with the latter four groups being unsubstituted or substituted with one or more groups independently selected from halo, OH, NH₂, NHC₁₋₆alkyl, N(C₁₋₆alkyl)(C₁₋₆alkyl), OC₁₋₆alkyl and halo-substituted C₁₋₆alkyl;
Y is a linker group;
q is an integer between, and including, 1-225; and
R⁴ is an activating group which activates the adjacent carbonyl group so that nucleophilic functionalities on one or more biological molecules will react therewith and said one or more biological molecules become covalently attached to said silicone polymer.

Also included within the scope of the present invention is a compound of Formula II:

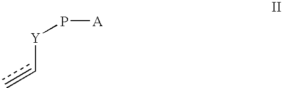

wherein
P is a water soluble polymer;
Y is a linker group; [symbol]
represents a double or triple bond; and
A is an activating group wherein said activating group reacts with reactive functionalities on one or more biological molecules.

Also included within the scope of the present invention is a compound of Formula IIa

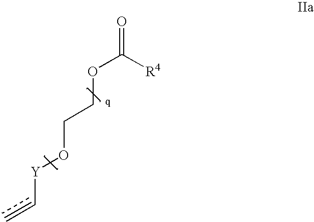

wherein [symbol]
represents a double or triple bond; and
Y is a linker group;
q is an integer between, and including, 1-225; and
R⁴ is an activating group which activates the adjacent carbonyl group so that nucleophilic functionalities on one or more biological molecules will react therewith and said one or more biological molecules become covalently attached to said silicone polymer.

In an embodiment of the invention, R⁴ is an N-hydroxysuccinimidyl (NHS) group:

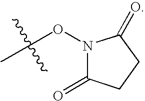

The compounds of Formula II, may be reacted with silicone materials bearing Si—H surface functional groups, using standard hydrosilylation conditions, to provide compounds of Formula I.

The compounds of Formula I may then be reacted with reactive functionalities, for example nucleophilic functionalities, on any biological molecule to provide silicone surfaces that are biocompatible for a variety of applications.

Accordingly, the present invention further includes a method of preparing a biocompatible silicone material comprising reacting compounds of Formula I, as defined above, with one or more biological molecules bearing reactive functionalities, so that the one or more biological molecules becomes covalently attached to said compounds of Formula I.

The present invention also provides methods of using the biocompatible silicone materials in biodiagnostic, biosensor and bioaffinity applications, as well as for coatings, for example, for in vivo bioimplantation and for reactors liners exposed to biological broths, such as fermentors.

The present invention relates to a simple two step procedure to modify the biocompatibility of any silicone material. The silicone materials represented by Formula I are generic in that they will react with any reactive functionality, in particular alcohols and amines, making the surface readily amenable to modification by biomolecules. The density of groups attached to the silicone material can be varied as can the nature of groups to facilitate rejection or attraction of available biomolecules. The polymers of Formula I have a well defined structure, that has been fully characterized. The biomolecule-modified silicone materials made from the polymers of Formula I can be any surface, including flat sheets, solid objects, coated objects and even surfaces having complicated shapes.

Other features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The present invention will now be described in greater detail with reference to the following drawings in which:

FIG. 1 shows FT-IR spectra of: (a) PDMS; (b) Si—H modified PDMS; (c) succinimidyl carbonate PEG-modified PDMS surfaces 3, (d) RGD-modified 9, and (e) YIGSR-modified 10 PDMS surfaces, respectively.

FIG. 2 shows survey XPS spectra: (a) unmodified PDMS; (b) succinimidyl carbonate PEG-3, (c) RGDS-PEG 9, and, (d) YIGSR PEG modified-PDMS 10 surfaces.

FIG. 3 is a bar graph showing the water contact angle of control, RGDS 9 and YIGSR 10 modified surfaces.

FIG. 4 is a bar graph showing contact angle data for heparinized silicone surfaces.

FIG. 5 is a bar graph showing binding EGF to the surfaces: PDMS=control, PDMS-PEO=modified surface as disclosed below.

FIG. 6 shows A: Adsorption of albumin on the control and 2 giving 5 before and after washing with SDS. B: Adsorption of fibrinogen onto albumin coated control or onto 5 giving 6. C: Surfaces coated with albumin, then fibrinogen, and then washed with SDS.

FIG. 7 shows A: Adsorption of lysozyme onto various silicone surfaces before and after exposure to SDS.

FIG. 8 shows adsorption of plasminogen from plasma.

FIG. 9 shows the ability of thrombin to process N-p-tosyl-gly-pro-arg p-nitroanilide under various conditions.

FIG. 10 shows Human Corneal Epithelial Cells (HCEC) grown on control, RGDS 4 and YIGSR 5 modified surface (7 days).

FIG. 11 shows the NMR assignments of 2.

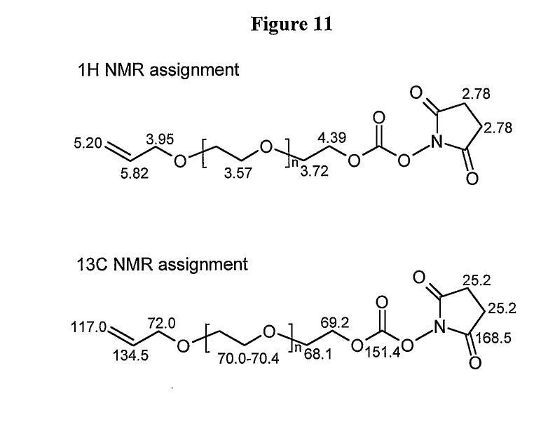

FIG. 12 shows a calibration curve for measuring total heparin density.

FIG. 13 shows the growth of human corneal epithelial cells on A: control (silicone), B: PEO-modified silicone, C: EGF-coated silicone or D: 4.

FIG. 14 shows thrombin inactivation by AT bound to heparin surface 13 and versus AT directly bound to 3.

### DETAILED DESCRIPTION OF THE INVENTION

Silicone surfaces have been modified with a flexible, asymmetric linker which provides materials with activated ester-terminated, PEO-modified surfaces. These surfaces react effectively with reactive functionalities, such as amines and alcohols, and thus serve as key intermediates in the preparation of saccharide-, peptide-, nucleotide-modified and analogous surfaces. The resulting surfaces may be tailored to be selectively repellent or adherent to biomolecules and, as a result, biocompatible in a variety of applications.

Accordingly, the present invention relates to a silicone polymer having a modified surface wherein said modification consists of a covalently attached water soluble polymer bearing an activating group, wherein said activating group reacts with reactive functionalities on one or more biological molecules so that said one or more biological molecules become covalently attached to said silicone polymer.

In embodiments of the invention, the silicon polymer may be tethered to another polymer through crosslinking or be part an interpenetrating network or be an elastomeric species by forming bridges with adjacent polymer chains.

In an embodiment of the invention, the water soluble polymer is, selected from any such compound and includes, but is not limited to, polyethers, for example, polyethylene oxide (PEO), polyethylene glycol (PEG), amino-terminated polyethylene glycol (PEG-NH₂), polypropylene glycol (PPG), polypropylene oxide (PPO), polypropylene glycol bis(2-amino-propyl ether) (PPG-NH₂); polyalcohols, for example, polyvinyl alcohol; polysaccharides, e.g. dextran and related compounds; poly(vinyl pyridine); polyacids, for example, poly(acrylic acid); polyacrylamides e.g. poly(N-isopropylacrylamide) (polyNIPAM); and polyallylamine (PAM). In a further embodiment of the invention, the water soluble polymer is PEO, or a modified PEO. In a further embodiment of the invention, the PEO has a molecular weight of up to about 2000 g/mol, more specifically up to about 1000 g/mol. By “water soluble” it is meant that the polymer is capable of being formed into an aqueous solution having a suitable concentration. It should be noted that the terms “oxide” (as in polyethylene oxide) and “glycol” (as in polyethylene glycol) may be used interchangeably and the use of one term over the other is not meant to be limiting in any way.

The activating group on the water soluble polymer and the reactive functionalities on the biological molecule are designed so that they are complementary and will react with each other to form a covalent linkage. For example, when the activating group is an activated carboxylic acid, the reactive functionalities on the biological molecule would comprise a nucleophile, for example an amine, alcohol or thiol.

The present invention further relates to a silicone polymer having the general Formula I:

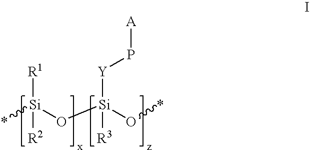

wherein
x is an integer between, and including, 1-20000;
z is an integer between, and including, 1 and 1000;
R¹, R² and R³ are each, independent of one another, selected from H, C₁₋₃₀alkyl, C₂₋₃₀alkenyl, C₂₋₃₀alkynyl and aryl, with the latter four groups being unsubstituted or substituted with one or more groups independently selected from halo, OH, NH₂, NHC₁₋₆alkyl, N(C₁₋₆alkyl)(C₁₋₆alkyl), OC₁₋₆alkyl and halo-substituted C₁₋₆alkyl;
Y is a linker group;
P is a water soluble polymer; and
A is an activating group wherein said activating group reacts with reactive functionalities on one or more biological molecules so that said one or more biological molecules become covalently attached to said silicone polymer.

The polymers of Formula I may also be tethered to another polymer using, for example, the substituents on R¹, R² and/or R³, or through crosslinking, or may be the result of the formation of an interpenetrating network. The polymer of Formula I may also be an elastomer, in which R¹, R² and/or R³ forms a bridge to an adjacent polymeric chain. Reactions to effect the formation of such co-polymers and elastomers are known to those skilled in the art.

The polymers of Formula I include those in which x is an integer between, and including, 1-20000. In an embodiment of the invention x is an integer between and including, 5-600, suitably 10-600.

The polymers of Formula I include those in which z is an integer between, and including, 1-1000. In an embodiment of the invention z is an integer between and including, 1-60.

The term “halo” as used herein means halogen and includes chloro, fluoro, bromo and iodo. In an embodiment of the invention, halo is fluoro.

The term “C₁₋ₙalkyl” as used herein means straight and/or branched chain, saturated alkyl radicals containing from one to n carbon atoms and includes (depending on the identity of n) methyl, ethyl, propyl, isopropyl, n-butyl, s-butyl, isobutyl, t-butyl, 2,2-dimethylbutyl, n-pentyl, 2-methylpentyl, 3-methylpentyl, 4-methylpentyl, n-hexyl and the like.

The term “C₁₋ₙalkenyl” as used herein means straight and/or branched chain, unsaturated alkyl radicals containing from one to n carbon atoms and one or more, suitably one or two, double bonds, and includes (depending on the identity of n) vinyl, allyl, 2-methylprop-1-enyl, but-1-enyl, but-2-enyl, but-3-enyl, 2-methylbut-1-enyl, 2-methylpent-1-enyl, 4-methylpent-1-enyl, 4-methylpent-2-enyl, 2-methylpent-2-enyl, 4-methylpenta-1,3-dienyl, hexen-1-yl and the like.

The term “C₁₋ₙalkynyl” as used herein means straight and/or branched chain, unsaturated alkyl radicals containing from one to n carbon atoms and one or more, suitably one or two, triple bonds, and includes (depending on the identity of n) ethynyl, propargyl, 1-propynyl, 1-octynyl, and the like.

The term “halo-substituted C₁₋ₙalkyl” as used herein means a C₁₋ₙalkyl group substituted with one or more halo, in particular 1 or more fluoro, and includes CF₃, CF₂CF₃, CH₂CF₃, and the like.

The term “aryl” as used herein means a monocyclic or bicyclic carbocyclic ring system containing one or two aromatic rings and from 6 to 14 carbon atoms and includes phenyl, naphthyl, anthraceneyl, 1,2-dihydronaphthyl, 1,2,3,4-tetrahydronaphthyl, fluorenyl, indanyl, indenyl and the like.

In the polymers of Formula I, R¹, R² and R³ are each, independent of one another, selected from H, C₁₋₃₀alkyl, C₂₋₃₀alkenyl, C₂₋₃₀alkynyl and aryl, with the latter four groups being unsubstituted or substituted with one or more groups independently selected from halo, OH, NH₂, NHC₁₋₆alkyl, N(C₁₋₆alkyl)(C₁₋₆alkyl), OC₁₋₆alkyl and halo-substituted C₁₋₆alkyl. In an embodiment of the invention, R¹, R² and R³ are each, independent of one another, selected from H, C₁₋₁₀alkyl, C₂₋₁₀alkenyl, C₂₋₁₀alkynyl and aryl, with the latter four groups being unsubstituted or substituted with one or more groups independently selected from halo, OH, NH₂, NHC₁₋₄alkyl, N(C₁₋₄alkyl)(C₁₋₄alkyl), OC₁₋₄alkyl and halo-substituted C₁₋₄alkyl. In a further embodiment of the invention, R¹, R² and R³ are each, independent of one another, selected from H, C₁₋₄alkyl, C₂₋₄alkenyl, C₂₋₄alkynyl and phenyl, with the latter four groups being unsubstituted or substituted with one or more groups independently selected from F, Cl, OH, NH₂, NHCH₃, N(CH₃)₂, OCH₃ and CF₃. In a still further embodiment of the invention, R¹, R² and R³ are each, independent of one another, selected from H, C₁₋₄alkyl, C₂₋₄alkenyl and C₂₋₄alkynyl. In even further embodiments of the invention R¹, R² and R³ are each, CH₃.

The linker group, Y, may be any suitable bivalent group. In an embodiment of the invention Y comprises at least one CH₂ group between the silicon atom and the polymer, P. In a further embodiment of the invention, Y is —(CH₂)ₜ—, wherein t is an integer between and including 1 and 30, suitably between 1 and 10, more suitably 3.

In an embodiment of the invention, the water soluble polymer, P, is polyethylene oxide, and the activating group is an activated carboxylic acid. Accordingly, the present invention further relates to a silicone polymer having the general Formula Ia:

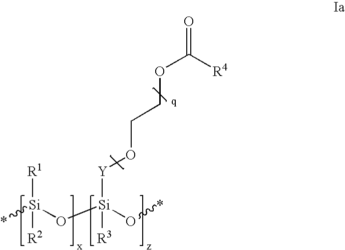

wherein
x is an integer between, and including, 1-20000;
z is an integer between, and including, 1 and 1000;
R¹, R² and R³ are each, independent of one another, selected from H, C₁₋₃₀alkyl, C₂₋₃₀alkenyl, C₂₋₃₀alkynyl and aryl, with the latter four groups being unsubstituted or substituted with one or more groups independently selected from halo, OH, NH₂, NHC₁₋₆alkyl, N(C₁₋₆alkyl)(C₁₋₆alkyl), OC₁₋₆alkyl and halo-substituted C₁₋₆alkyl;
Y is a linker group;
q is an integer between, and including, 1-225; and
R⁴ is an activating group which activates the adjacent carbonyl group so that nucleophilic functionalities on one or more biological molecules will react therewith and said one or more biological molecules become covalently attached to said silicone polymer.

In the compounds of Formula Ia, q is an integer between and including 1 and 225. In an embodiment of the invention, q is an integer between and including, 2 and 100, specifically between 4 and 11.

In the polymers of Formula I, A may be any suitable functional group with complementary reactivity to functional groups on the biological molecule. In an embodiment of the invention A is an electrophilic functional group that reacts with nucleophilic functional groups on the biological molecule. A person skilled in the art would appreciate that there are many functional groups that are capable of reacting with nucleophiles, such as amines, alcohols and thiols, in biological molecules to form a covalent linkage between the biological molecule and the polymer. In an embodiment of the invention, A and —C(O)—R⁴, in Formulae I and Ia, respectively, form an activating group that is used in peptide synthesis, for example a carbodiimide, an anhydride, an activated ester or an azide, In an embodiment of the invention, R⁴ is selected from p-nitrophenyl (i), perfluorophenyl (ii), imidazolyl (iii) or related N-heterocycles and N-hydroxysuccinimidyl (iv) (NHS):

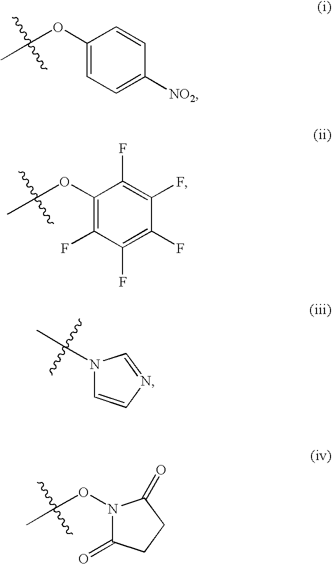

In further embodiments of the invention, R⁴ is NHS.

Also included within the scope of the present invention is a compound of Formula II:

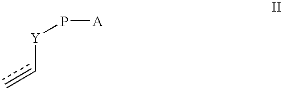

wherein
P is a water soluble polymer;
Y is a linker group; [symbol]
represents a double or triple bond; and
A is an activating group wherein said activating group reacts with reactive functionalities on one or more biological molecules.

In an embodiment of the invention, [symbol] represents a double bond.

Further, the present invention also includes a compound of Formula IIa

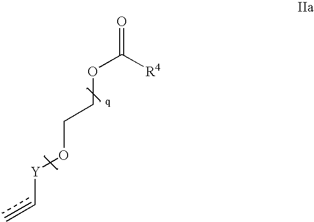

wherein [symbol]
represents a double or triple bond; and
Y is a linker group;
q is an integer between, and including, 1-225; and
R⁴ is an activating group which activates the adjacent carbonyl group so that nucleophilic functionalities on one or more biological molecules will react therewith and said one or more biological molecules become covalently attached to said silicone polymer.

The term “biological molecule” as used herein refers to any molecule known to be found in biological systems and includes, amino acids, proteins, peptides, nucleic acids (including DNA and RNA), saccharides, polysaccharides and the like. Biological molecules include those which are naturally occurring as well as those which have been modified using known techniques.

The term “biocompatible” as used herein means that the material either stabilizes proteins and/or other biomolecules against denaturation or does not facilitate denaturation. The term “biocompatible” also means compatible with in vivo use, in particular in animal subjects, including humans.

The “nucleophilic functionalities” on the biomolecule may be any nucleophilic group, for example, an amine (NH₂), hydroxy (OH) or thiol (SH) group. In an embodiment of the invention, the “nucleophilic functionality” is an amine (NH₂) or hydroxy (OH) group.

The compounds of Formula II, may be reacted with silicone materials bearing Si—H surface functional groups, using standard hydrosilylation conditions, to provide compounds of Formula I.

The compounds of Formula I may then be reacted with reactive functionalities on any biological molecule to provide silicone surfaces that are biocompatible for a variety of applications.

Accordingly, the present invention further includes a method of preparing a biocompatible silicone material comprising reacting compounds of Formula I, as defined above, with one or more biological molecules bearing reactive functionalities, so that the one or more biological molecules becomes covalently attached to said compounds of Formula I.

Also included within the scope of the present invention are biocompatible silicone materials prepared using this method.

Hydrosilylationconditions, for example, typically include reacting a Si—H modified silicone with a compound comprising a double or triple bond in the presence of a platinum catalyst, for example platinum-divinyltetramethyldisiloxane complex or Karstedt's catalyst, in a solvent at ambient temperatures.

Si—H modified silicones are well known in the art and are commercially available. An example of a Si—H modified silicone is DC1107 (MeHSiO)ₙ available from Dow Corning.

The compounds of Formula I may be reacted with the one or more biological molecules bearing reactive functionalities under standard conditions known to those skilled in the art. For example, when the reactive functionality is a nucleophile on a protein or peptide, the reaction may be carried out in a buffered solution, for example a buffer at pH of about 5-9.5, suitably at about 7-8.5.

The immobilization of amino acids, peptides, proteins, sugars, polysaccharides; nucleosides, nucleotides (RNA, DNA), etc., and modified versions thereof, is a commonly exploited strategy to change the chemistry of a surface. The modified surfaces may then be used for biodiagnostic, biosensor, bioaffinity, and related applications. They may also be used to change the nature of subsequent deposition of biomolecules so that in vivo applications such as antithrombogenic coatings on stents, shunts and catheters or nonfouling contact lens surfaces can be achieved. Less complex, but equally important applications include non-fouling surfaces on membranes or in vessels used for fermentation. Silicones are also extremely useful as coating materials (conformal coatings are easy to prepare from silicones).

Biomaterials destined for implantation generally should not be recognized as a foreign body. If they are recognized as foreign at all, the interactions with the body must be extremely weak. One of the first events that takes place after implantation is the adsorption of proteins on the substrate surface, which initiates a cascade of biological events, generally to the detriment of the biomaterial. Minimizing this behaviour, and particularly any subsequent changes in protein structure (denaturing) after deposition is one of the main challenges which remain in bioimplantable materials. Silicone materials modified with PEO are demonstrably excellent at repelling a series of proteins. By contrast, the silicone materials of the present invention are readily surface modified with amino acids, peptides, proteins or carbohydrates. These tethered biomolecules retain their bioactivity and further interact with other biomolecules in the environment. Thus, the surfaces of the present invention will be useful for in vivo implantation and for liners exposed to biological broths (e.g., fermentation, drug delivery systems, etc.). In addition to implantation, there will be other applications in coatings.

According, the present invention relates to a method of coating a surface to modulate biocompatibility comprising applying silicone material of Formula I, as defined above, to said surface.

The term “modulate” as used herein means to increase or decrease or otherwise change a function or activity in the presence of a substance, compared to otherwise same conditions in the absence of the substance.

The present invention also provides methods of using the biocompatible silicone materials in biodiagnostic, biosensor and bioaffinity applications, in addition to coatings, for example, for in vivo transplantation and for liners exposed to biological broths.

While the following Examples illustrate the invention in further detail, it will be appreciated that the invention is not limited to the specific Examples.

### EXAMPLES

### Materials and Methods

### (a) Reagents

Poly(ethylene glycol) monoallylether (average MW 500) was obtained as a gift from JuTian Chemical Co. (Nanjing, China). It was dried by azeotropic distillation with toluene before use. N,N-Disuccinimidyl carbonate, o-xylene (97%, anhydrous), triethylamine (99%), acetonitrile (99%, anhydrous), Karstedt's Pt catalyst (2-3 wt % in xylene, [(Pt)₂(H₂C═CH—SiMe₂OSiMe₂CH═CH₂)₃]), 2-mercaptoethanol, CF₃ SO₃H were purchased from Aldrich Chemical Co. Sylgard 184 (a platinum cured silicone rubber H₂C═CH-Silicone+HSi-silicone→Silicone-CH₂CH₂Si-silicone) and DC1107 (MeHSiO)ₙ were purchased from Dow Corning (Midland, Mich.). Human serum albumin (HSA), Tyr-Ile-Gly-Ser-Arg (YIGSR), Arg-Gly-Asp-Ser (RGDS) and Sephadex G-25 columns were obtained from Sigma. Epidermal growth factor (EGF) was obtained from RDI. Fibrinogen was obtained from Enyzme Research Laboratories. Toluene was dried by refluxing over Na prior to distillation, and MeOH was dried by refluxing over Mg and was distilled before use.

### (b) Materials Characterization

¹H and ¹³C NMR spectra were recorded at 30° C. on a Bruker AC-200 spectrometer (at 200 MHz and 50.3 MHz for ¹H and ¹³C, respectively).

Attenuated Total Reflection Fourier Transform IR Spectroscopy (ATR-FTIR) measurements were carried out on a Bruker VECTOR 22 Fourier transform infrared spectrometer (Bruker Instruments, Billerica, Mass.) equipped with Harrick ATR accessory MUP with GeS crystal; 200 scans were collected for each sample.

Electrospray mass spectra (ESI-MS) were recorded on a Micromass Quattro LC, triple quadruple MS.

### 1.2 Materials Characterization

Water contact angle Advancing and receding sessile drop contact angles were measured on PEO grafted surfaces using a Ramé Hart NRL C.A. goniometer (Mountain Lakes, N.J.). Milli-Q water (18 MΩ/cm) was used with a drop volume of approximately 0.02 mL. Results are presented as an average of 18 measurements or more on at least three different surfaces. Contact angles were also measured using the captive bubble method, where an air bubble was injected from a syringe onto an inverted sample surface immersed into Milli-Q water. Results are presented as the average of at least 10 measurements on three different surfaces.

X-ray photoelectron spectroscopy (XPS) was performed at Surface Interface Ontario, University of Toronto using a Leybold Max 200 X-ray photoelectron spectrometer with a MgK-α non-monochromatic X-ray source.

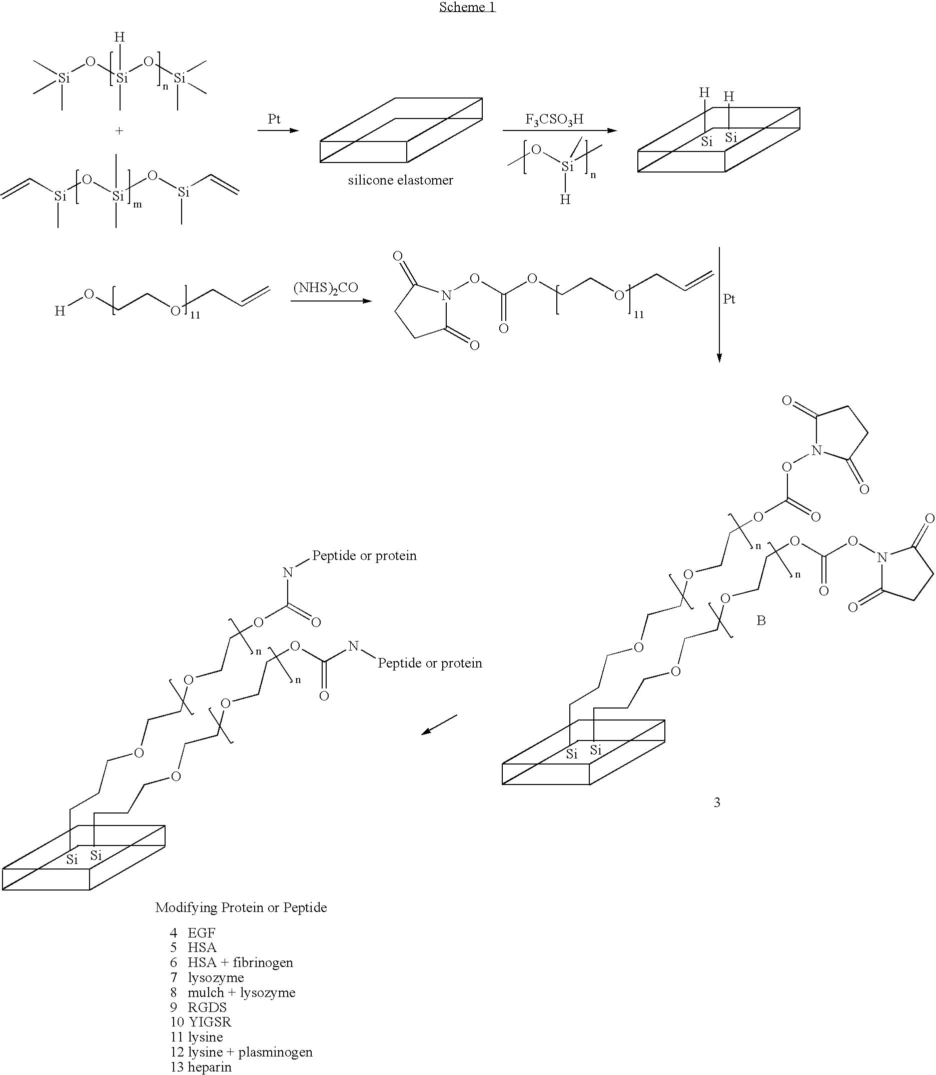

In the following examples refer to Scheme I for the structures corresponding to the compound numbers.

### Example 1

### Preparation of N-Succinimidyl Carbonate PEG Grafted PDMS Surfaces

### (a) Synthesis of α-allyl-ω-N-succinimidyl carbonate-poly(ethylene glycol), 2

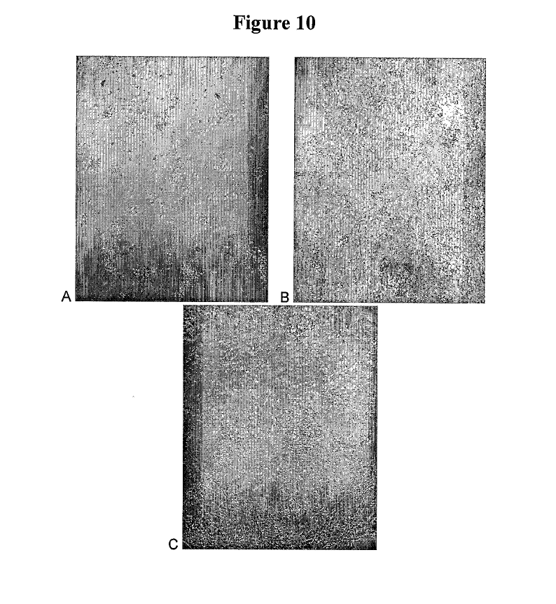

To a solution of poly(ethylene glycol) monoallylether (2.0 g, 4.0 mmol) and triethylamine (1.62 g, 16 mmol) in CH₃CN (10 mL) was added N,N′-disuccinimidyl carbonate (4.1 g, 16 mmol). The mixture was allowed to stir at room temperature over 10 h under N₂. After removal of the solvent in vacuo, the residue was dissolved in dry toluene (25 mL) and the solution was cooled to 0° C. A pale brown precipitate was filtered off. The toluene was removed under reduced pressure. This procedure was repeated 3 times. The resultant compound 2 was a yellow oil (1.2 g, 60% yield). IR (neat): 1739 (NC═O), 1788 (OC═O). ¹H NMR (200.2 MHz, CDCl₃, FIG. 10): δ 2.78 (s, 4H, O═CCH₂CH₂C═O), 3.57 (bs, 40H, PEG's OCH₂), 3.72 (bs, 2H, OCH₂CH₂OC═O), 3.95 (d, 2H, J=5.6 Hz, CH₂═CHCH₂O), 4.39 (m, 2H, OCH₂CH₂OC═O), 5.20 (m, 2H, CH₂═CHCH₂O), 5.82 (m, 1H, CH₂═CHCH₂O) ppm. ¹³C NMR (50.3 MHz, CDCl₃): δ 25.2 (O═CCH₂CH₂C═O), 68.1 (OCH₂CH₂OC═O), 69.2 (O═COCH₂CH₂O), 70.4 (PEG's OCH₂), 72.0 (CH₂═CHCH₂O), 117.0 (CH₂═CHCH₂O), 134.5 (CH₂═CHCH₂O), 151.4 (OC═OO), 168.5 (NC═OCH₂) ppm. MS (ESI): m/z=745.6 (M+NH₄⁺, n=12, 100).

### (b) Elastomer Preparation

Silicone elastomers were prepared according to the procedure provided by Dow Corning. Sylgard 184 PDMS pre-polymer and catalyst was mixed thoroughly with its cross-linker in a 10:1 ratio (w/w) in a plate mold and degassed under vacuum. Films were allowed to cure at room temperature for 48 h. After curing, the silicone elastomer films were punched into disks, approximately 5 mm in diameter and 0.5 mm thick. The disks were washed with hexane and then dried under vacuum for further use.

### (c) Si—H Surface Functionalization 1

For Si—H functionalization of the surface, 20 silicone elastomer disks were immersed in a mixture of DC1107 (3 mL) and methanol (5 mL). To this was added F₃CSO₃H (0.02 mL, 0.26 mmol). After stirring at room temperature for 30 min, the functionalized surfaces were rinsed with methanol and hexane, and dried under vacuum (for surface characterization, see below).

### (d) Addition of PEG Derivative: 3

Si—H modified silicone surfaces 1 were incubated in a solution of 2-methoxyethyl ether solvent and 2 (80:20 wt %:wt %, 3 mL). Pt-catalyst (platinum-divinyltetramethyldisiloxane complex, 1 drop) was added and the mixture was stirred for 15 h at room temperature. Following modification, the PEG modified surfaces 3 were washed thoroughly with dry acetone and dried under vacuum.

### Example 2

### Characterization of NHS and Modified Surfaces

### ATR-FTIR

As described above, N,N-disuccinimidyl carbonate was used to activate the hydroxy-terminal of α-allyl-ω-polyethylene glycol. The desired compound 2 was obtained as determined by ¹H NMR, with the resonance of the —CH₂—CH₂— on the NHS (2.78 ppm) being diagnostic. Two types of C═O were observed on the NHS-activated termini, and the O—C(O)—O linkage were detected by ¹³C NMR (168.8 ppm and 151.7 ppm, respectively). Assignment of the FT-IR spectrum of the NHS-activated PEO is outlined in Table 1. The band at 1739 cm⁻¹, representing the C═O stretch of the NHS group, can be used to further diagnose the succinimidyl carbonate PEG grafting process.

H—Si functionalized silicone surfaces 1 were obtained by acid-catalyzed equilibration of a silicone elastomer in the presence of (MeHSiO)ₙ as noted above The ATR-FTIR spectra of the resulting surfaces exhibited a band at 2166 cm⁻¹ due to the Si—H stretch. The succinimidyl carbonate PEO was grafted onto the silicone rubber surfaces via a hydrosilylation reaction with the H—Si groups. In the FTIR spectrum of the succinimidyl carbonate PEG grafted surfaces 3, the band at 2166 cm⁻¹ due to H—Si was no longer visible following the reaction. There were two C═O stretches at 1741 and 1789 cm⁻¹, respectively, that were assigned to the C═O groups at the succinimidyl carbonate termini, and the O—C(O)—O linkage, which was also present in the starting material. The PEO CH₂ scissoring band at 1454 cm⁻¹, the antisymmetric stretch mode of the CH₂—O—CH₂ chain at 1351 cm⁻¹, and the symmetric stretch mode of the CH₂—O—CH₂ chain at 1258 cm⁻¹ indicated the presence of PEO chains at the resulting surface. XPS

NHS-PEO binding to the surface 3 was further by the presence of an N1s signal in the XPS survey scan due to the amine groups in the NSC-PEO polymer. The C1s high resolution spectrum shows a distinct peak at 286.4 eV which corresponds to the C—C—O bond in PEO repeat unit.

### Example 3

### Conjugation of Various Molecules to the NHS-Modified Surface

### (a) Peptide Conjugation

The covalent conjugation of peptide to the functionalized surfaces was carried out in a phosphate buffered saline (PBS) buffer solution (pH 7.5). The N-succinimidyl carbonate PEG grafted surfaces 3 were immersed in PBS buffer containing the peptide RGDS or YIGSR, (10 μg/mL) for 12 h to give 9 or 10, respectively. After rinsing three times with PBS for 10 min, for a total of 30 min, the surfaces were dried under vacuum.

### (b) Characterization

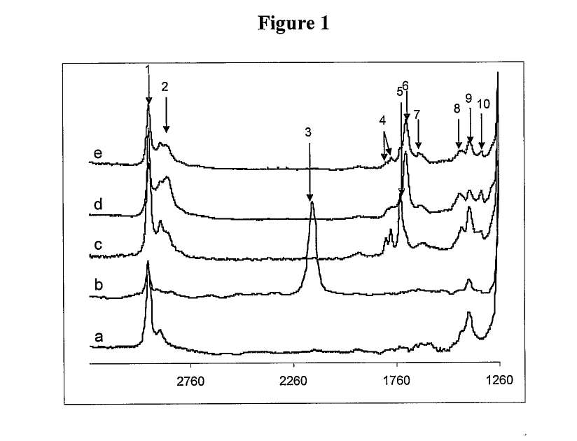

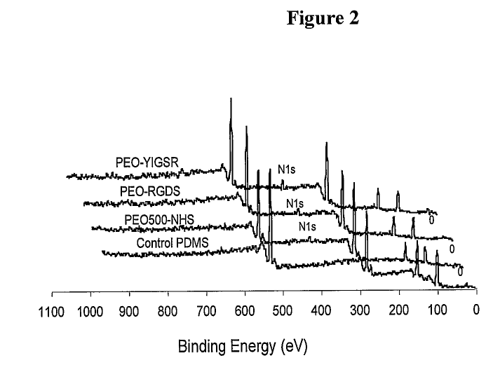

The IR spectra of modified surfaces 3, 9 and 10, respectively, are shown in FIG. 1. Distinct bands at 1652 cm⁻¹ and 1656 cm⁻¹ (Table 1,) due to amide I, were observed on both the RGDS- and YIGSR-modified surfaces: the C═O stretch mode at 1741 cm⁻¹, due to the NHS group, disappeared in both cases following modification. These spectral changes indicated the coupling of the succinimidyl carbonate PEG to the peptides. Peptide immobilization was further demonstrated by an increase in the XPS N1s signal to 1.9 and 2.7% for RGDS and YIGSR, respectively, due to the amine groups in the peptides and a decrease in the Si2p signal as shown in Table 2. Note that the starting succinimidyl carbonate PEO-modified PDMS 3 showed very weak nitrogen peak due to the single nitrogen in NHS. The nitrogen intensity, post modification, was much higher (FIG. 2).

### (c) EGF Conjugation 4

The covalent conjugation of EGF to the functionalized surfaces was carried out in a phosphate buffered saline (PBS) solution (pH 7.4). EGF was first labeled with ¹²⁵I (ICN Pharmaceuticals, Irvine Calif.) using the iodogen method. The N-succinimidyl carbonate PEG grafted surface 3 was immersed in a PBS buffer (pH 7.4) containing radiolabeled EGF (10 μg/mL) for 2 and 24 h, rinsed three times with PBS for 10 minutes each, (30 minutes total), wicked onto filter paper to remove residual adherent buffer, transferred to clean tubes, and their radioactivity determined by counting using a gamma counter. Radioactivity counts were converted to surface protein concentrations. One milliliter of a 2% sodium dodecyl sulfate (SDS) solution was then added to each tube and left at room temperature for 4 h and overnight at 4° C. After three PBS rinses, the surfaces were transferred to clean tubes and radioactivity measured to determine the levels of EGF remaining after the SDS treatment, which indicated that the growth factor was covalently immobilized to the surface.

### (d) Human Serum Albumin Conjugation 5

Human serum albumin was labeled with ¹²⁵I (ICN Pharmaceuticals, Irvine Calif.) using the ICl method. The labeled protein was passed through an AG 1-X4 column (Bio-Rad Laboratories, Hercules, Calif., USA) to remove any free iodide. For measurement of non-specific adsorption of protein from buffer and covalent coupling of albumin to the surfaces, a mixture of labeled and unlabeled protein (1:20) at a total concentration of 1 mg/mL was prepared. NHS-PEO modified surfaces 3 were incubated with albumin for 2 h at room temperature, rinsed three times with PBS for 10 min, (250 μL per rinse per disk, 30 minutes total), wicked onto filter paper to remove residual adherent buffer, transferred to clean tubes, and the radioactivity determined by counting using a gamma counter. Radioactivity was converted to the protein amounts bound to the surfaces. To confirm covalent attachment, one milliliter of a 2% sodium dodecyl sulfate (SDS) solution was then added to each tube and left overnight. After three 10 min rinses (250 μL per rinse), the surfaces were transferred to clean tubes and activity measured again to determine the levels of protein remaining after the SDS treatment.

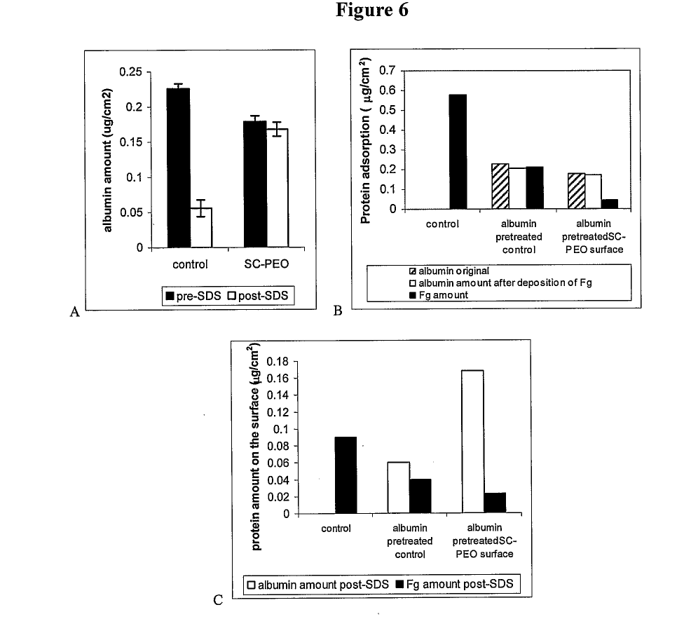

A summary of adsorption or covalent grafting of albumin is shown in FIG. 6. The albumin concentration was 0.226 μg/cm² on the control silicone surfaces. Surfaces modified with the N-succinimidyl carbonate PEG 3 had less albumin, with a surface density of 0.179 μg/cm²; however this albumin is believed to be covalently bound. After both surfaces were treated with SDS solution for 24 h, the albumin concentration on the control surface decreased to 0.056 μg/cm² while albumin concentration on NHS-PEG modified surfaces remained almost unchanged at 93% of the original value (0.168 μg/cm²). This observation is consistent with the covalent binding of most of the albumin to the silicone through PEG spacers. FIG. 6 shows the results of fibrinogen adsorption on the albumin pretreated surfaces.

### (e) Fibrinogen Adsorption 6

Fibrinogen was labeled with ¹³¹I (ICN Pharmaceuticals, Irvine Calif.) using the ICl method. The labeled protein was passed through an AG 1-X4 column (Bio-Rad Laboratories, Hercules, Calif., USA) to remove any free iodide. The untreated control (PDMS elastomer) surface, ¹²⁵I-albumin pretreated control surface and ¹²⁵I-albumin pretreated NHS-PEG modified surfaces 5 were incubated in PBS solution containing the radiolabelled fibrinogen at a concentration of 1 mg/mL for 2 h. The fibrinogen amounts on various surfaces were determined radioactively as described above (FIG. 6).

### (f) Conjugation of Mucin 8

NHS surfaces 3 were incubated in 5 mg/mL solution of mucin from bovine (submaxillary glands, Type I-S, Sigma) in PBS buffer (pH=8.0) for 6 h. Surfaces were subsequently rinsed three times with fresh PBS.

### (g) Conjugation of Lysozyme 7

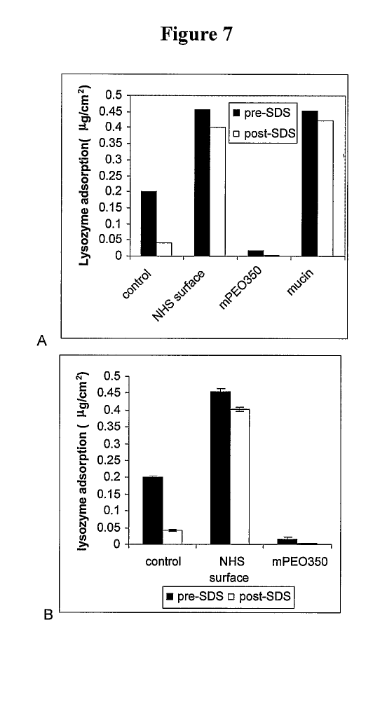

Lysozyme adsorption to various surfaces was carried out in a phosphate buffered saline (PBS, pH 7.4). Lysozyme was labeled with ¹²⁵I (ICN Pharmaceuticals, Irvine Calif.) using the ICl method. The N-succinimidyl carbonate PEG grafted surface 3, PEG350 grafted surface, mucin modified surface and control surface, respectively, were immersed in a PBS buffer (pH 7.4) containing (unlabeled: radiolabeled=9:1) lysozyme (1 mg/mL) for 3 h, rinsed three times with PBS for 10 minutes each, (30 minutes total), wicked onto filter paper to remove residual adherent buffer, transferred to clean tubes, and their radioactivity determined by counting using a gamma counter. Radioactivity counts were converted to surface protein concentrations. One mL of a 2% sodium dodecyl sulfate (SDS) solution was then added to each tube and left at room temperature for 4 h and overnight at 4° C. After three PBS rinses, the surfaces were transferred to clean tubes and the radioactivity was measured to determine the levels of lysozyme remaining after the SDS treatment (FIG. 7).

### (h) Lysine Surface 11

Surface 3 was incubated in solution of H-Lys(Fmoc)-OH (Chem-Impex International. Inc., 1 mg/mL) in hexafluoroisopropanol (HFIP, Aldrich) for 6 h. After rinsing three times with HFIP and then incubated in piperidine (Aldrich, 20% in DMF) for 2 h. Surfaces were washed with PBS buffer (10 mL) 3 times (1 h/wash).

(i) Plasminogen Adsorption from Plasma

Plasminogen was radiolabeled with Na ¹²⁵I (ICN, Irvine, Calif.), using the ICl method. Labeled plasminogen was added to pooled acid citrate dextrose human plasma as a tracer and then exposed to control surface, surface 3 and lysine grafted surface 11, respectively, for 3 h at room temperature. Surfaces were rinsed three times with fresh PBS prior to γ counting.

### (j) Heparin Conjugation 13

NHS surfaces 3 were incubated in 10 mg/mL solution of heparin (Sigma Aldrich) in PBS buffer (pH=8.0) for 6 h. Surfaces were subsequently rinsed three times with fresh PBS. The density of heparin on the NHS surface 13 is 0.68 μg/cm² as shown by the calibration curve (see next section). More than 90% of this heparin was active as determined by a hepanorm standard assay.

A series of heparin standard solutions with concentrations varying from 0 to 20 μg/mL were prepared by diluting a stock solution. The stock solution was obtained by dissolving 10 mg heparin in an aqueous 0.2 wt % NaCl solution.

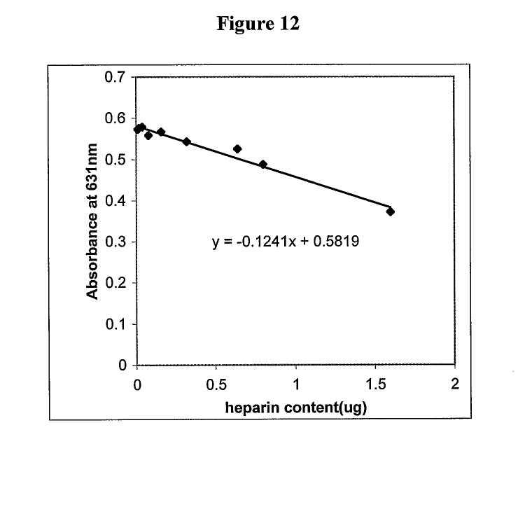

Toluidine blue (Sigma-Aldrich Canada, 50 mg) was dissolved in HCl (1 mL, 0.01 N solution), in which 0.2 wt % NaCl had been previously added and dissolved. The 50 mg/mL toluidine blue solution was diluted to a 0.005 mg/mL (0.0005%) toluidine blue solution with deionized water. The solution (1.0 mL) was added to a 5 mL tube, then 0.1 mL of the above heparin standard solution was added. The mixed solution was vortexed by a Vortex mixer for 30 s. n-Hexane (Aldrich-Sigma Canada) 1 mL was added and the solution was vigorously mixed for 30s, and then allowed to separate into 2 phases over 5 min. The heparin-toluidine blue complex was extracted into the upper transparent organic layer. After the organic layer was removed, the absorbance of the aqueous layer at 63 nm was measured on a Beckman DU640UV/VIS spectrophotometer. A linear standard calibration curve was obtained by plotting absorbance at 631 nm versus concentration of heparin in the aqueous NaCl solution (FIG. 12). The amount of heparin immobilized on the polymer surfaces was determined by this calibration curve. The activity of the heparin on the surface was determined using a hepanorm assay, based on the interaction of Factor Xa with heparin. Heparinized surfaces and standard solutions were incubated with hepanorm, antithrombin III in PBS buffer and the activity of the solutions and the heparinized surfaces determined.

Prior to testing, polymer samples were incubated in 0.05 M Tris-buffered saline (TBS) with pH7.4 at room temperature overnight to hydrate the surfaces. For each experiment, 0.1 mL of 0.2% NaCl solution and 1.0 mL of 0.005 mg/mL (0.0005%) toluidine blue solution were mixed in a 5 mL polypropylene test tube. The heparin-modified (polymer) surfaces 13 with 0.77 cm² area were immersed in the solution, which was vortexed for 30 s. Then, 1 mL n-hexane was added and well shaken. The mixture was allowed to phase-separate for 5 min after removal of the surfaces. As above, the upper organic layer was removed and the absorbance of the aqueous layer at 631 nm was investigated on a Beckman DU640 UV/VIS spectrophotometer. The density of total heparin immobilized on the surfaces was calculated from the above calibration curve. For each surface, the heparin density was expressed by mass per unit surface area (μg/cm²)

### (k) Thromboresistant Properties

Platelin® was obtained from Organon Teknila Corp., Durham, N.C., USA (No. 35501). TBS/Ca²⁺/Platelin® (0.1M CaCl₂ with a 1:10 dilution of platelin) buffer solution was made by dissolving CaCl₂ (1.11 g) and 4 standard vials of Platelin® in 10 mL of Milli-Q water (10 mL). The volume was then brought to 100 mL with TBS (0.05 M, pH=7.4). Thrombin substrate N-p-tosyl-gly-pro-arg p-nitroanilide (Sigma-Aldrich) (5 mg) was dissolved in TBS (10 mL) to give a solution with a final concentration of 0.5 mg/mL.

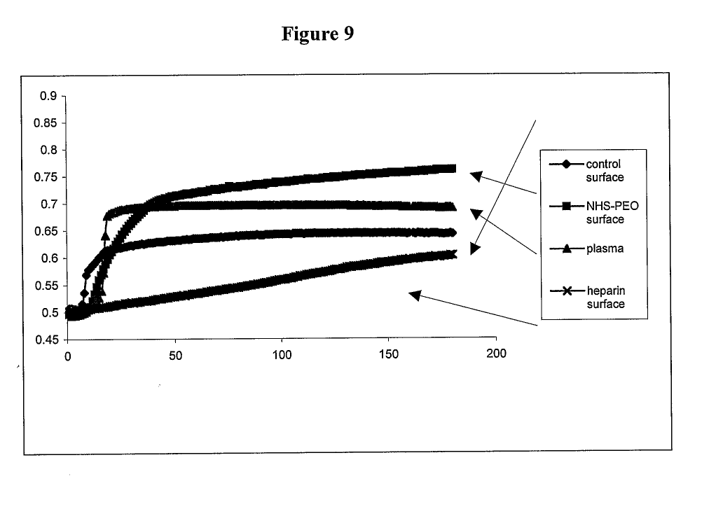

In order to passivate the walls of the 96-wells microtitration plate, the wells were exposed to human serum albumin in TBS (10 mg/mL) overnight at 4° C. The albumin solution was then withdrawn from the wells and the wells were aspirated and washed three times with fresh TBS (0.3 mL/well/time) before adding the unmodified and heparin modified silicone surfaces. The heparin-modified surface was incubated in antithrombin TBS buffer solution (0.25 mg/mL) for 30 minutes before testing. The disks were placed vertically in the wells and 10% diluted pooled human citrated plasma (200 μL) was added to the wells. After the plate was warmed to 37° C., TBS/Ca²⁺/platelin buffer solution (20 μL) and thrombin substrate (30 μL of 0.5 mg/mL) were added. The release of p-nitroaniline by thrombin was measured as a function of time by recording the optical density at 405 nm and 37° C. using a UV-Vis plate reader (FIG. 9).

### (l) Cell Culture on Peptide Modified Surfaces

Surfaces (˜5 mm disks) 9 or 10 as well as controls were washed three times with PBS supplemented with antibiotics (penicillin, streptomycin and gentamycin) and subsequently stored overnight at 4° C. in Keratinocyte Serum Free Medium (KSFM, Invitrogen, Grand Island N.Y.) medium containing antibiotics. Under sterile conditions, the surfaces were transferred to a 24 well plate and plated with human corneal epithelial cells (HCECs, 10⁴ cells per well) in KSFM supplemented with penicillin, streptomycin, gentamycin and EGF. The cells were cultured at 37° C. in 5% CO₂. Samples were imaged at 24, 48, 72 and 96 h. All images were taken at 100× magnification (FIG. 10).

### Discussion for Examples 1-3

Unlike most polymers, silicones can be readily formed, and degraded, under thermodynamic control (²⁸). Thus, treatment of monomers and/or polymers with endcapping molecules in the presence of acid or base, allows the preparation of homo- or copolymers of various molecular weights. By carefully controlling the swelling conditions, using relatively poor solvents for silicone such as methanol, it was possible to preferentially introduce Si—H surface functional groups to a variety of pre-cured silicone elastomers giving 1 by a redistribution polymerization with triflic acid (²⁹), as readily shown by the characteristic strong IR absorption at 2166 cm⁻¹ (FIG. 1, Table 1). This group underwent efficient hydrosilylation with a series of olefins, including allyl-PEO and, more importantly¹³, allyl-PEO-NHS 2, prepared by the reaction of allyl-PEO-OH with bis-N-hydroxysuccinimidyl carbonate (Scheme 1) to give a high density, reactive NHS surface 3. Surface properties (ATR-IR, XPS, FIG. 1, FIG. 2) were determined using traditional methods (see Experimental Section).

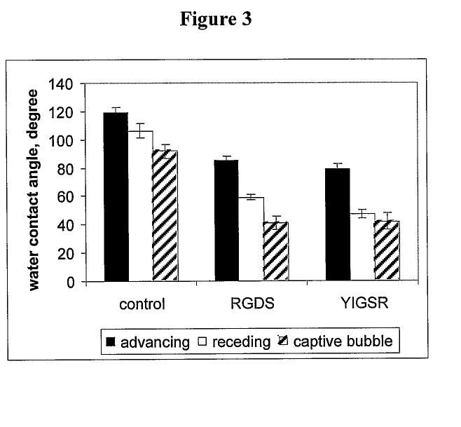

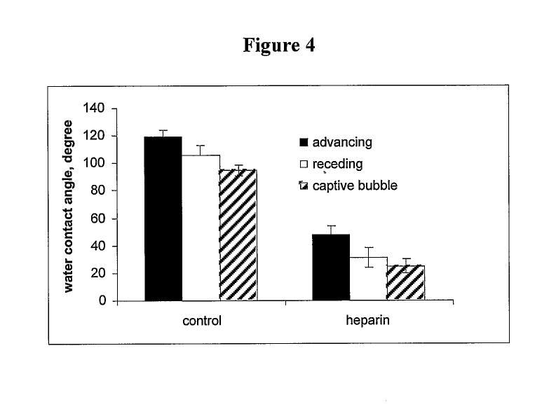

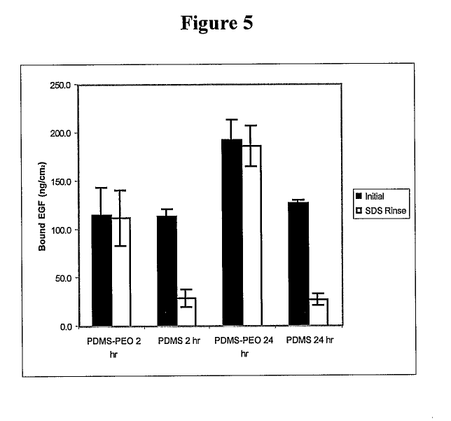

The NHS group was chosen as the functional group to link surface 3 to biomolecules because it is mild, selective for amines over alcohols, and reacts with both groups much faster than with water. A series of proteins, peptides and amino acids including epidermal growth factor (EGF, 4), human serum albumin (HSA, 5) plus fibrinogen (6), lysozyme (7), mucin plus lysozyme (8), the cell adhesion peptides Arg-Gly-Asp-Ser (RGDS, 9) and Tyr-Ile-Gly-Ser-Arg (YIGSR, 10), lysine (11), lysine plus plasminogen (12) and heparin (13) were bonded to the modified silicone 3 in phosphate buffered saline (PBS) solutions (pH=8.0). The resulting surfaces were characterized by the techniques mentioned above (FIG. 1, FIG. 2, FIG. 3, FIG. 4, Table 2). The total quantities of the linked and adsorbed peptides or proteins were determined by radioactivity assays before and after exhaustively washing the modified surface with sodium dodecyl sulfate (SDS). This method also provided a minimum estimate of the total graft density of the surface. For example, after 24 hours of reaction with EGF, the resulting surface 4 exhibited a surface concentration of 190 ng/cm² (ca. 0.2 EGF molecules/nm²): After washing, the control surface showed 26 ng/cm² while the EGF-g-PEO surface was essentially unchanged (FIG. 5). This surface concentration is comparable to the high densities found on model SAM-modified gold surfaces (³⁰). Since the molecular weight of EGF is ca. 6000, the graft density of 0.2/nm² is presumably an underestimation of available Si—H groups and of the PEO density; some of the active NHS groups on the surface will likely be sterically blocked by covalently linked protein. Lysozyme (MW ca. 14000) was analogously grafted to the surface. After extensive washing with SDS, 402 ng/cm² (0.15 molecules/nm²) remained, giving an even more efficient surface coverage than with EGF. Similarly, heparin was found on the surface with a graft density of 0.68 μg/cm² (see below).

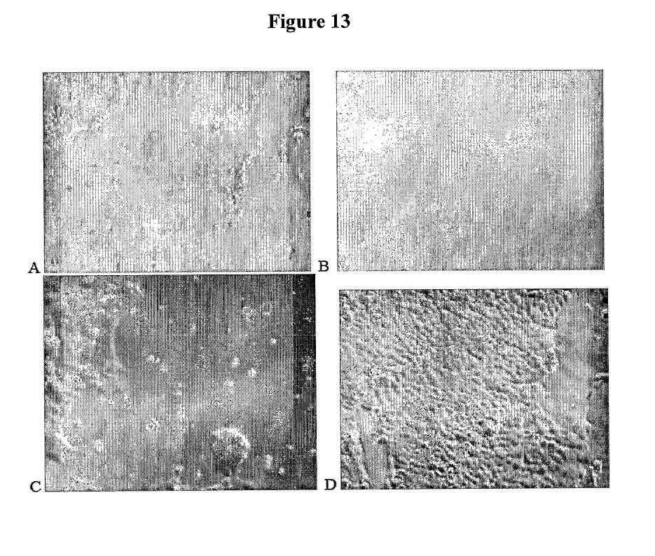

In order to assay the bioactivity of the grafted EGF, the surface 4 was cultured with human corneal epithelial cells in the absence of serum. However, unlike other studies in which various proteins including EGF and a bovine pituitary extract are added back to the medium, the cells were cultured in medium with antibiotics only, eliminating any potential exogenous effects. Patches of cell growth were clearly evident on the EGF modified surfaces; there were no cells adherent on either the bare PDMS or on the PEO modified PDMS surfaces, demonstrating that the EGF attached to the surfaces was active and able to stimulate cell proliferation and extracellular matrix production (FIG. 13).

Albumin, the most abundant protein in blood, can be used to passivate implanted synthetic surfaces (³¹). Less protein was initially found on the NHS-modified surface 5 than on the control (0.22 vs 0.18 μg/cm², FIG. 6A). However, the control surface was mostly washed free of the ¹²⁵I-labeled protein with SDS (0.05 μg/cm² remained), while 0.17 μg/cm² remained on the functionalized surface. This data is consistent with initial protein physisorption that was converted to chemisorption 5, before the protein can migrate across the NHS surface to form a monolayer. That is, the albumin binds on contact, leaving a non-coherent film and accessible interstitial areas. Attempts to form a coherent albumin film prior to covalent linkage, by controlling the rate of surface binding, have not so far been successful.

The ability to displace the albumin by ¹³¹I-labeled fibrinogen, from control and 5 surfaces, respectively, was examined. Fibrinogen adsorbed effectively to the control surface, without accompanying loss of the albumin already present there, whereas much less fibrinogen was able to contact and bind to the albumin passivated NHS surface FIG. 6B to give 6 (control 0.58 ng/cm² vs 6 0.045 ng/cm²) both before and after washing with SDS FIG. 6C. This is consistent with a control surface in which albumin can be “nudged aside” by fibrinogen, but a covalently linked surface 5 in which only a few interstitial spaces are sufficiently large to accommodate the large fibrinogen molecule (340 kD) giving 6.

Lysozyme, one of the proteins responsible for ophthalmic disinfection, was exposed to a variety of modified silicones. Significantly more lysozyme was adsorbed to the pre-grafted mucin 8 and NHS-surfaces 3 (0.173 molecules/nm²) than the control or simple PEO surfaces (^{13,32,33})(FIG. 7). The natural surface with which lysozyme interacts in the eye is mucin (³⁴). Thus, this modified polymer may prove useful as a model system to examine surface fouling by lysozyme in ophthalmic applications.

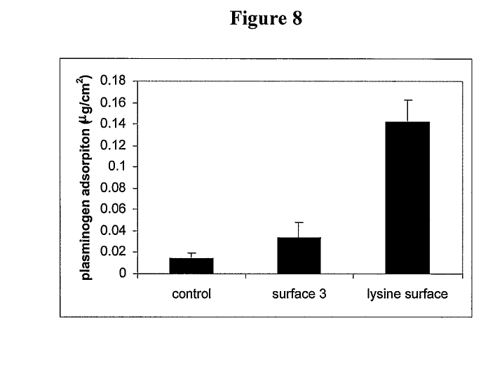

Analogous chemistry may be used to prepare a lysine rich surface. Exposure of Fmoc-protected lysine (the ε amine group was protected by Fmoc) to 3 followed by deprotection with piperidine led to the amino acid (containing a free ε amine group)-modified surface 11. It is now established that lysine rich surfaces are particularly attractive to plasminogen, which both recognizes and binds the amino acid (^{35,36,37}). It was demonstrated that 3 is a generic surface to which amines will bind. However, as shown in FIG. 8, plasminogen adsorbs only marginally more effectively to 3, (giving 12), than to the control silicone. By contrast, a ten fold increase in plasminogen adsorption is found on the lysine surface. Previous reports (³⁵) showed that surface-bond plasminogen was readily converted to plasmin in the presence of tissue plasminogen activator (t-PA), and enzymatic activity increased with increasing surface density of ε-amine free lysine. The disclosed surface design exploits surface bound lysine through PEO as spacer that can repel non-specific proteins and selectively bind plasminogen. It furthermore demonstrates that binding via interaction with lysine is far more effective (four fold) than the formation of a covalent linkage with the surface.

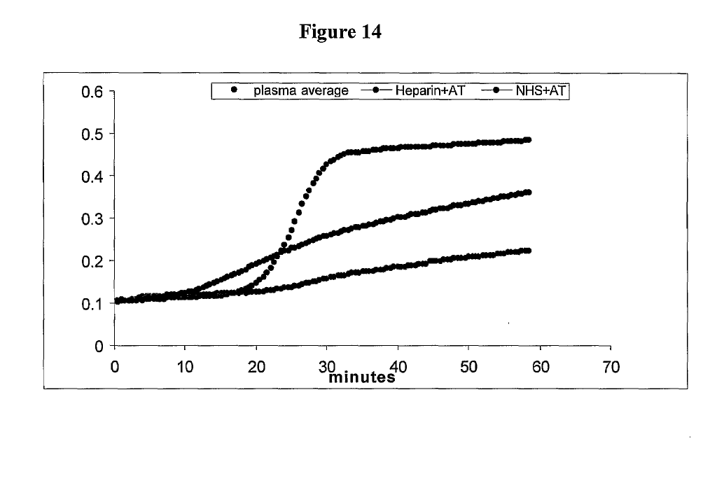

Previous work has demonstrated that surfaces with high densities of conjugated lysine, prepared using an industrially developed process, are able to lyse incipient clots (^{34,35,36}). In the current work, a similar assay was performed with lysinated surfaces 12. The activity of the plasmin (plasminogen was activated by t-PA) on these surfaces was clear. There was little or no clot formation based on the assay parameters used (increase in optical density) suggesting that these surfaces are highly non-thrombogenic. Current experiments are examining whether 12 is acting as an inhibitor of clot formation and/or whether the surface is simply extremely efficient at clot lysis. Irrespective, the surface shows a lower degree of clot formation than those previously described (^{34,35,36}) Heparin, a highly sulfonated, anionic polysaccharide that is a well known antithrombotic agent, was analogously grafted with high density and high activity (0.68 μg/cm², ˜90%) to the 3 surface giving 13. The surface was subsequently exposed to thrombin, via interaction of CaCl₂ with plasma, in the presence of the chromogenic substrate N-p-tosyl-gly-pro-arg p-nitroanilide (the generation of thrombin would normally be expected in a relatively static system such as that used). Release of the p-nitroaniline hydrolysis product was followed over 3 hours (FIG. 9). Although nitroaniline was formed in the presence of 13, it did so at a significantly lower rate and with a significantly longer half life than the case observed with plasma alone, or in the presence of the control silicone surface or the NHS-PEO-modified surface 3. The heparinized surface is demonstrably less thrombogenic than the other surfaces examined or those described in previous reports (³⁸). More interesting was the observation that antithrombin 3 complexed to the heparin surface 13 giving 14 silicone surface was far more efficient at inhibiting thrombin than AT3 directly bound to the surface (FIG. 14).

An important consideration for any biomedical surface is the degree to which it is accepted by the local biological environment. Human corneal epithelial cells (HCEC) were cultured on NHS surfaces modified with the cell adhesion peptides RGDS and YIGSR, 9 and 10, respectively, under serum free conditions. As shown in FIG. 10, cells readily adhere to, spread and mitose on the peptide modified surfaces 9 and 10 to give confluent monolayers in less than 96 hours. Significantly lower levels of confluence were observed on both the control and PEO modified surfaces, respectively: even with highly biocompatible PEO-modified silicone surfaces (¹³), confluent layers of corneal cells have previously been not possible to achieve.

Several research groups have previously examined methods to generically graft biomolecules to surfaces. For example, NHS surfaces were prepared as self assembled monolayers on gold surfaces (²⁹). However, these surfaces are not readily adaptable to complex devices themselves, or to coatings on devices comprised of other polymers. The surfaces described herein were shown to bind comparable or higher levels of biomolecules even when compared to model gold systems.

It is extremely easy to form complex shapes or to conformally coat a variety of substrates with silicones. The surface modifications described in the present work are amenable to any silicone elastomer, irrespective of cure chemistry. This process offers advantages over previous methods because activating groups, such as NHS groups, can be introduced to the surface in high density; this is facilitated by the absence of water, such that PEO swelling is reduced (⁹). The activating groups, for example the NHS groups, provide a generic route to graft biomolecules to the surfaces.

The generic nature of these modified silicone surfaces is amply demonstrated by the wide variety of biomolecules that can be readily grafted to them, and the maintenance of their bioreactivity after modification, which compatibilizes the surface.

While the present invention has been described with reference to what are presently considered to be the preferred examples, it is to be understood that the invention is not limited to the disclosed examples. To the contrary, the invention is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

TABLE 1
Assignment of FT-IR spectra of succinimidyl carbonate
PEG and modified surfaces (see FIG. 1 for spectra).

| | Wavenumber (cm⁻¹) | | | | | |
|---|---|---|---|---|---|---|
| | NHS- | H—Si | NHS-PEO | ROD | YIGSR | |
| Peak | PEO | surface | surface | surface | surface | Assignment |
| 1 | 29 | 2966 | 2961 | 2961 | 2 | C—H stretch |
| | 65 | | | | 9 | |
| | | | | | 6 | |
| | | | | | 1 | |
| 2 | 28 | | 2873 | 2874 | 2 | Glycol CH₂ |
| | | | | | | stretch |
| | 68 | | | | 8 | |
| | | | | | 7 | |
| | | | | | 4 | |
| 3 | — | 2166 | — | — | — | Si—H |
| | | | | | | stretch |
| 4 | 17 | — | 1789 | | | C═O (on |
| | | | | | | O—C(O)—O |
| | 88 | | | | | linkage) |
| | | | | | | stretch |
| 5 | 17 | — | 1741 | — | — | C═O |
| | | | | | | (on NHS |
| | 40 | | | | | group) |
| | | | | | | stretch |
| 6 | 17 | — | 1715 | 1713 | 1 | |
| | 17 | | | | 7 | |
| | | | | | 1 | |
| | | | | | 3 | |
| 7 | — | — | — | 1652 | 1 | Amide I |
| | | | | | 6 | stretch |
| | | | | | 5 | |
| | | | | | 6 | |
| 8 | 14 | | 1456 | 1449 | 1 | Glycol CH₂ |
| | | | | | | scissoring |
| | 54 | | | | 4 | |
| | | | | | 5 | |
| | | | | | 3 | |
| 9 | 14 | 1410 | 1411 | 1411 | 1 | |
| | 10 | | | | 4 | |
| | | | | | 0 | |
| | | | | | 9 | |
| 10 | 1351 | | 1351 | 1348 | 1 | Glycol |
| | | | | | 3 | (OCH₂—CH₂) |
| | | | | | 5 | chain anti- |
| | | | | | 0 | symmetric |
| | | | | | | stretch |

^{a} Refers to peak numbers in FIG. 1

TABLE 2
XPS Surface Analysis of Unmodified PDMS, succinimidyl
carbonate PEO modified 3, RGDS-PEO modified 9 and
YIGSR-PEO modified 10 PDMS surfaces

| Elemental | Control PDMS | NHS-PEO | RGDS-PEO | YIGSR-PEO |
|---|---|---|---|---|
| C | 46 | 52.2 | 54.6 | 55.4 |
| N | 0 | 0.9 | 1.9 | 2.7 |
| O | 26.5 | 26.3 | 25.2 | 26.5 |
| Si | 27.4 | 20.6 | 18.4 | 15.5 |

### FULL CITATIONS FOR DOCUMENTS REFERRED TO IN THE SPECIFICATION

¹B. Ratner, A. Hoffman, F. Schoen, J. Lemons, Biomaterials Science (Academic, New York, 1996).
²P. C. Nicolson et al. U.S. Pat. No. 5,965,631 (CIBA Vision and CSIRO) 1999.
³M. Shen, M. S. Wagner, D. G. Castner, B. D. Ratner, T. A. Horbett, Langmuir 19, 1692 (2003).
⁴M. Shen, L. Martinson, M. S. Wagner, D. G. Castner, B. D. Ratner, T. A. Horbett J. Biomater. Sci. Polym. Ed. 13, 367 (2002).
⁵J. J. Gray Curr. Opin. Struct. Biol. 14, 110 (2004).
⁶E. Ostuni, R. G. Chapman, R. E. Holmlin, S. Takayama and G. M. Whitesides, Langmuir 17, 5605 (2001).
⁷R. G. Chapman, E. Ostuni, M. N. Liang, G. Meluleni, E. Kim, L. Yan, G. Pier, H. S. Warren and G. M. Whitesides. Langmuir 17, 1225 (2001).
⁸J. M. Harris and S. Zalipsky, Polyethylene glycol: chemistry and biological applications. Washington D.C.: American Chemical Society (1997).
⁹P. Kingshott, H. Thissen, H. J. Griesser, Biomaterials 23, 2043 (2002).
¹⁰M. S., S. Pasche, D. G. Castner, M. Textor Anal. Chem. 76, 1483 (2004).
¹¹D. L., J. A. Hubbell Annu. Rev. Mater. Sci. 26, 365 (1996).
¹²P., H. J. Griesser Curr. Opin. Solid State Mater. Sci. 4, 403 (1999).
¹³H. Chen, M. A. Brook, H. Sheardown, Biomaterials 25, 2273 (2004).
¹⁴A. Ragheb, M. A. Brook, M. Hrynyk, Chem. Commun. 2314 (2003).
¹⁵J. L. Brash, J. Biomater. Sci. Polym. Edn. 11: 1135-46. 2000
¹⁶V. Bartzoka, M. R. McDermott, M. A. Brook, Adv. Mater. 11, 257 (1999).
¹⁷J. M. Anderson, N. P. Ziats, A. Azeez, M. R. Brunstedt, S. Stack, T. L. Bonfield, J. Biomater. Sci. Polym. Edn. 7, 159 (1995).
¹⁸Sheu M S, Hoffman A S, Ratner B D, Feijen J, Harris J M, Immobilization of poly(ethylene oxide) surfactants on non-fouling biomaterial surfaces using an argon glow discharge treatment. J Adhesion Sci Tech. 1993; 7: 1065-76.
¹⁹Lee J H, Jeong B J, Lee H B. Plasma protein adsorption and platelet adhesion onto comb-like gradient surface. J Biomed Mater Res 1997; 34: 105-114.
²⁰Lassen B, Holmberg K, Brink C, Carlen A, Olsson J. Binding of salivary proteins and oral bacteria to hydrophobic and hydrophilic surface in vivo and in vitro. Colloid Polym Sci 1994; 272: 1143-1150.
²¹Kingshott P, Griesser H J. Surfaces that resist bioadhesion. Curr Opin Solid State Mater Sci 1999; 4: 403-12.
²²Hu S W, Ren X Q, Bachman M, Sims C E, Li G P, Albritton N. Surface modification of poly(dimethylsiloxane) microfluidic devices by ultraviolet polymer grafting. Anal. Chem. 2002; 74: 4117-4123.
²³Papra A, Bernard A, Juncker D, Larsen N B, Michel B, Delamarche E. Microfluidic networks made of poly(dimethylsiloxane), Si, and Au coated with polyethylene glycol for patterning proteins into surfaces. Langmuir 2001; 17: 4090-4095.
²⁴Merrett K, Griffith C M, Deslandes Y, Pleizier G, Sheardown H. Interactions of corneal epithelial cells with transforming growth factor b2 modified poly dimethyl siloxane surfaces J Biomed Mater Res 2003; 67A: 981-993.
²⁵Olander B, Wirsen A, Albertsson A C. Oxygen microwave plasma treatment of silicone elastomer: Kinetic behavior and surface composition J Appl Polym Sci 2004; 91: 4098-4104.
²⁶Widenhouse, C. W. Goldberg, E. P. Method for the surface modification of silicone surfaces for medical goods. PCT Patent Application Publication No. WO 2003030940, Apr. 17, 2003.
²⁷Jon S, Seong J, Khademhosseini A, Tran T N T, Laibinis P E, Langer R. Construction of nonbiofouling surfaces by polymeric self-assembled monolayers. Langmuir 2003; 19: 9989-93.
²⁸J. Chojnowski, Polymerization, in Siloxane Polymers, S. J. Clarson, J. A. Semlyen, Eds., (PTR Prentice Hall, Englewood Cliffs, N.J., 1993), Chap. 1.
²⁹G. Kossmehl, D. Quast, H. Schafer U.S. Pat. No. 4,332,922 (to Titmus Eurocon), 1982.
³⁰N. Xia, Y. Hu, D. W. Grainger, D. G. Castner Langmuir 18, 3255 (2002).
³¹C. C. Lawrence, W. Yuan, A. B. Shanafelt U.S. Pat. Appl., 20030092201, 2003.
³²H. Chen, M. A. Brook, Y. Chen, H. Sheardown, Surface Properties of PEO-Silicone Composites, Reducing Protein Adsorption, J. Biomaterials, Sci., Polym. Ed. 16, 531 (2005).
³³H. Chen, Z. Zhang, Y. Chen, M. A. Brook, H. Sheardown, Protein Repellant Silicone Surfaces by Covalent Immobilization of Poly(Ethylene Oxide), Biomaterials, 26, 2391 (2005).
³⁴H. J. Davidson, V. J. Kuonen Vet. Opthalmol. 7, 71 (2004).
³⁵W. G. McClung, D. L. Clapper, A. B. Anderson, D. E. Babcock, J. L. Brash J. Biomed Mat. Res.: A 66A, 795 (2003)
³⁶W. G. McClung, D. L. Clapper, S. P. Hu, J. L. Brash Biomaterials 22, 1919 (2001).
³⁷W. G. McClung, D. L. Clapper, S. P. Hu, J. L. Brash J. Biomed. Mat. Res. 49, 409 (2000).
³⁸M. V. Sefton, A. Sawyer, M. Gorbet, J. P. Black, E. Cheng, C. Gemmell, E. Pottinger-Cooper. J Biomed Mater Res. 55 447-59 (2001).

1. A silicone polymer having a modified surface wherein said modification consists of a covalently attached water soluble polymer bearing an activating group, wherein said activating group reacts with reactive functionalities on one or more biological molecules so that said one or more biological molecules become covalently attached to said silicone polymer.

2. The silicone polymer according to claim 1, wherein the water soluble polymer is selected from polyethers, polyalcohols, polysaccharides, poly(vinyl pyridine), polyacids, polyacrylamides and polyallylamine (PAM).

3. The silicone polymer according to claim 2, wherein the water soluble polymer is selected from polyethylene oxide (PEO), polyethylene glycol (PEG), amino-terminated polyethylene glycol (PEG-NH₂), polypropylene glycol (PPG), polypropylene oxide (PPO), polypropylene glycol bis(2-amino-propyl ether) (PPG-NH₂), polyvinyl alcohol, dextran, poly(vinyl pyridine), poly(acrylic acid), poly(N-isopropylacrylamide); (polyNIPAM) and polyallylamine (PAM).

4. The silicone polymer according to claim 3, wherein the water soluble polymer is PEO.

5. The silicone polymer according to claim 4, wherein the PEO has a molecular weight of up to about 2000 g/mol.

6. The silicone polymer according to claim 4, wherein the PEO has a molecular weight of up to about 1000 g/mol.

7. The silicone polymer according to claim 1, wherein the activating group is an activating group used in peptide synthesis and the reactive functionalities on the biological molecule comprises a nucleophile.

8. The silicone polymer according to claim 7, wherein the activating group is selected from a carbodiimide, an anhydride, an activated ester and an azide,

9. The silicone polymer according to claim 7, wherein the nucleophile is an amine, alcohol or thiol.

10. The silicone polymer according to claim 9, wherein the nucleophile is an amine or alcohol.

11. The silicone polymer according to claim 1 which is tethered to another polymer through crosslinking or which is part an interpenetrating network or which is an elastomeric species formed by bridging with adjacent polymer chains.

12. The silicone polymer according to claim 1, having the general Formula I: 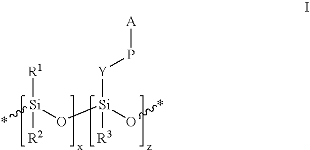
wherein
x is an integer between, and including, 1-20000;
z is an integer between, and including, 1 and 1000;
R¹, R² and R³ are each, independent of one another, selected from H, C₁₋₃₀alkyl, C₂₋₃₀alkenyl, C₂₋₃₀alkynyl and aryl, with the latter four groups being unsubstituted or substituted with one or more groups independently selected from halo, OH, NH₂, NHC₁₋₆alkyl, N(C₁₋₆alkyl)(C₁₋₆alkyl), OC₁₋₆alkyl and halo-substituted C₁₋₆alkyl;
Y is a linker group;
P is a water soluble polymer; and
A is an activating group wherein said activating group reacts with reactive functionalities on one or more biological molecules so that said one or more biological molecules become covalently attached to said silicone polymer.

13. The polymer according to claim 12, which is tethered to another polymer using the substituents on R¹, R² and/or R³, or through crosslinking, or which is part an interpenetrating network.

14. The polymer according to claim 12, wherein x is an integer between and including, 5-600.

15. The polymer according to claim 12, wherein z is an integer between and including, 1-60.

16. The polymer according to claim 12, wherein R¹, R² and R³ are each, independent of one another, selected from H, C₁₋₁₀alkyl, C₂₋₁₀alkenyl, C₂₋₁₀alkynyl and aryl, with the latter four groups being unsubstituted or substituted with one or more groups independently selected from halo, OH, NH₂, NHC₁₋₄alkyl, N(C₁₋₄alkyl)(C₁₋₄alkyl), OC₁₋₄alkyl and halo-substituted C₁₋₄alkyl.

17. The polymer according to claim 16, wherein R¹, R² and R³ are each, independent of one another, selected from H, C₁₋₄alkyl, C₂₋₄alkenyl, C₂₋₄alkynyl and phenyl, with the latter four groups being unsubstituted or substituted with one or more groups independently selected from Cl, F, OH, NH₂, NHCH₃, N(CH₃)₂, OCH₃ and CF₃.

18. The polymer according to claim 17, wherein R¹, R² and R³ are each, independent of one another, selected from H, C₁₋₄alkyl, C₂₋₄alkenyl and C₂₋₄alkynyl.

19. The polymer according to claim 18, wherein R¹, R² and R³ are each CH₃.

20. The polymer according to claim 12, wherein Y comprises at least one CH₂ group between the silicon atom and the polymer, P.

21. The polymer according to claim 20, wherein Y is —(CH₂)ₜ—, and t is an integer between and including 1 and 30.

22. The polymer according to claim 21, wherein t is an integer between, and including, 1 and 10.

23. The polymer according to claim 22, wherein t is 3.

24. The polymer according to claim 12, wherein P is selected from polyethers, polyalcohols, polysaccharides, poly(vinyl pyridine), polyacids, polyacrylamides and polyallylamine (PAM).

25. The polymer according to claim 24, wherein P is selected from polyethylene oxide (PEO), polyethylene glycol (PEG), amino-terminated polyethylene glycol (PEG-NH₂), polypropylene glycol (PPG), polypropylene oxide (PPO), polypropylene glycol bis(2-amino-propyl ether) (PPG-NH₂), polyvinyl alcohol, dextran, poly(vinyl pyridine), poly(acrylic acid), poly(N-isopropylacrylamide); (polyNIPAM) and polyallylamine (PAM).

26. The polymer according to claim 25, wherein P is PEO.

27. The polymer according to claim 26, wherein the PEO has a molecular weight of up to about 2000 g/mol.

28. The polymer according to claim 27, wherein the PEO has a molecular weight of up to about 1000 g/mol.

29. The polymer according to claim 12, wherein A is an activating group used in peptide synthesis and the reactive functionalities on the biological molecule comprise a nucleophile.

30. The polymer according to claim 29, wherein A is selected from a carbodiimide, an anhydride, an activated ester and an azide,

31. The polymer according to claim 29, wherein the nucleophile is an amine, alcohol or thiol.

32. The polymer according to claim 31, wherein the nucleophile is an amine or alcohol.

33. The polymer according to claim 12, having the Formula Ia: 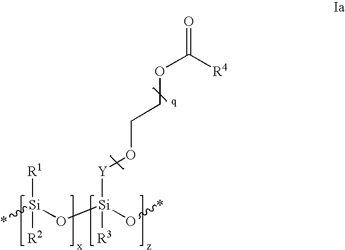
wherein
x is an integer between, and including, 1-20000;
z is an integer between, and including, 1 and 1000;
R¹, R² and R³ are each, independent of one another, selected from H, C₁₋₃₀alkyl, C₂₋₃₀alkenyl, C₂₋₃₀alkynyl and aryl, with the latter four groups being unsubstituted or substituted with one or more groups independently selected from halo, OH, NH₂, NHC₁₋₆alkyl, N(C₁₋₆alkyl)(C₁₋₆alkyl), OC₁₋₆alkyl and halo-substituted C₁₋₆alkyl;
Y is a linker group;
q is an integer between, and including, 1-225; and
R⁴ is an activating group which activates the adjacent carbonyl group so that nucleophilic functionalities on one or more biological molecules will react therewith and said one or more biological molecules become covalently attached to said silicone polymer.

34. The polymer according to claim 33, wherein q is an integer between, and including, 2 and 100.

35. The polymer according to claim 34, wherein q is an integer between, and including, 4 and 11.

36. The polymer according to claim 33, wherein R⁴ is selected from p-nitrophenyl (i), perfluorophenyl (ii), imidazolyl (iii) or related N-heterocycles and N-hydroxysuccinimidyl (iv) (NHS):

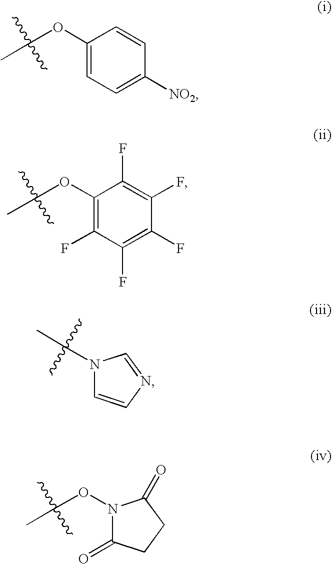

37. The polymer according to claim 36, wherein R⁴ is NHS.

38. A method of preparing a biocompatible silicone material comprising reacting polymers according to claim 1 with one or more biological molecules bearing reactive functionalities, so that the one or more biological molecules becomes covalently attached to said polymers.

39. The method according to claim 38, wherein the reactive functionality is a nucleophile and the reaction is carried out in a buffer at a pH of about 5-9.5.

40. The method according to claim 38, wherein the one or more biological molecules comprises amino acids, proteins or peptides.

41. The method according to claim 40, wherein the one or more biological molecules is selected from growth factors, human serum albumin, human serum albumin plus fibrinogen, lysozyme, mucin plus lysozyme, a cell adhesion peptide, lysine, lysine plus plasminogen and heparin.

42. A biocompatible silicone material prepared using the method according to claim 38.

43. A method of coating a surface to modulate biocompatibility comprising applying silicone material according to claim 42 to said surface.

44. The method according to claim 43, wherein the coated surface is used in biodiagnostic, biosensor or bioaffinity applications, or for coatings for in vivo transplantation or for liners exposed to biological broths.

45. A method of preparing a compound of Formula I according to claim 1 comprising reacting a compound of Formula II: 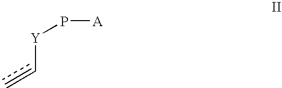
wherein
P is a water soluble polymer;
Y is a linker group; — [symbol]
represents a double or triple bond; and
A is an activating group wherein said activating group reacts with reactive functionalities on one or more biological molecules,
with a silicone material bearing reactive Si—H functional groups under hydrosilylation conditions.

46. The method according to claim 45, wherein the hydrosilylation include in the presence of a platinum catalyst and in a solvent at ambient temperatures.

47. The method according to claim 46, wherein the platinum catalyst is platinum-divinyltetramethyldisiloxane complex (Karstedt's catalyst).

48. The method according to claim 45, wherein [symbol] represents a double bond.

49. The method according to claim 45, wherein the compound of Formula II has the Formula IIa: 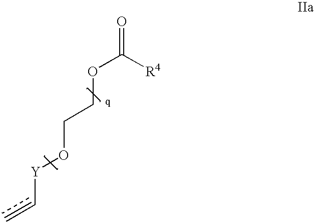
wherein [symbol]
represents a double or triple bond; and
Y is a linker group;
q is an integer between, and including, 1-225; and
R⁴ is an activating group which activates the adjacent carbonyl group so that nucleophilic functionalities on one or more biological molecules will react therewith and said one or more biological molecules become covalently attached to said silicone polymer.

50. A compound of Formula II: 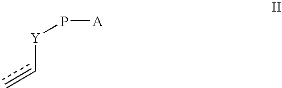
wherein
P is a water soluble polymer;
Y is a linker group; [symbol]
represents a double or triple bond; and
A is an activating group wherein said activating group reacts with reactive functionalities on one or more biological molecules.

51. The compound according to claim 50, wherein [symbol] represents a double bond.

52. The compound according to claim 50, having the Formula IIa: 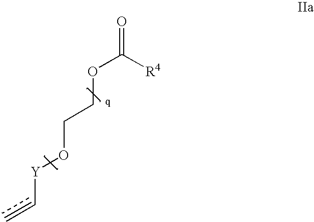
wherein [symbol]
represents a double or triple bond; and
Y is a linker group;
q is an integer between, and including, 1-225; and
R⁴ is an activating group which activates the adjacent carbonyl group so that nucleophilic functionalities on one or more biological molecules will react therewith and said one or more biological molecules become covalently attached to said silicone polymer.
